(19) United States
(12) Patent Application Publication
(10) Pub. No.: US 2025/0173963 A1
(43) Pub. Date: May 29, 2025

(54) SCREEN RECORDING METHOD AND APPARATUS OF EXTENDED REALITY DEVICE, DEVICE, MEDIUM, AND PROGRAM

(71) Applicant: Beijing Zitiao Network Technology Co., Ltd., Beijing (CN)

(72) Inventors: Yunfei FAN, Beijing (CN); Guidong WANG, Beijing (CN); Tao WU, Beijing (CN)

(21) Appl. No.: 18/955,908

(22) Filed: Nov. 21, 2024

(30) Foreign Application Priority Data
Nov. 28, 2023 (CN) 202311605702.8

(51) Int. Cl. G06T 17/00; G06T 3/18; G06T 5/20

(52) U.S. Cl. CPC G06T 17/00; G06T 3/18; G06T 5/20

(57) ABSTRACT

Embodiments of the present application provide a screen recording method and apparatus of an extended reality device, a device, a medium, and a program, comprising: acquiring a target pose corresponding to an XR device at time t, wherein the target pose is a pose at the time t or a first predicted pose at time t+m; performing pose stabilization processing on the target pose to obtain a stabilized pose, wherein the pose stabilization processing comprises performing reverse compensation on a roll angle of the target pose; performing screen recording on a rendering result of a virtual scene based on the stabilized pose to obtain a screen recording image at a time corresponding to the target pose, and storing the screen recording image.

### CROSS REFERENCE TO RELATED APPLICATIONS

The present application is based on and claims priority to Chinese Patent Application No. 202311605702.8 filed on Nov. 28, 2023, the disclosure of which is incorporated by reference herein in its entirety.

### TECHNICAL FIELD

Embodiments of the present application relate to the technical field of electronic devices, in particular to a screen recording method and apparatus of an extended reality device, a device, a medium, and a program.

### BACKGROUND

Extended Reality (XR) refers to the combination of reality and virtuality through computers to create a virtual environment with human-computer interaction. XR is also a general term for Virtual Reality (VR), Augmented Reality (AR), Mixed Reality (MR) and other technologies. Through the integration of the three visual interaction technologies, it brings the “immersion” of seamless transition between the virtual world and the real world to experiencers.

An XR device can store the content displayed in a period of time locally in the form of video through the screen recording operation, so that users can view it later or send it to other devices for playing. It is inevitable that the XR device will jitter when it is used. The screen recording is usually to capture and store the pictures displayed by the XR device. Therefore, the screen recording picture also has the problem of jitter, which leads to a serious sense of dizziness when users watch the screen recording picture.

### SUMMARY

Embodiments of the present application provide a screen recording method and apparatus of an extended reality device, a device, a medium, and a program, which can reduce the jitter of a screen recording picture and improve the screen recording quality.

In a first aspect, an embodiment of the present application provides a screen recording method of an extended reality device, which comprises:
acquiring a target pose corresponding to an extended reality XR device at time t, wherein the target pose is a pose at the time t or a first predicted pose at time t+m;
performing pose stabilization processing on the target pose to obtain a stabilized pose, wherein the pose stabilization processing comprises performing reverse compensation on a roll angle of the target pose;
performing screen recording on a rendering result of a virtual scene based on the stabilized pose to obtain a screen recording image at a time corresponding to the target pose, and storing the screen recording image.

In some embodiments, the performing reverse compensation on a roll angle of the target pose includes:
performing reverse compensation on the roll angle of the target pose, so that a value of the roll angle of the target pose after reverse compensation is a preset value.

In some embodiments, the performing reverse compensation on a roll angle of the target pose includes:
when the roll angle of the target pose is greater than or equal to a preset angle threshold, performing reverse compensation on the roll angle of the target pose, so that a value of the roll angle of the target pose after reverse compensation is a preset value or the angle threshold;
or, when the roll angle of the target pose is greater than or equal to a preset angle threshold, performing reverse compensation on the roll angle of the target pose according to a preset compensation angle.

In some embodiments, the performing reverse compensation on a roll angle of the target pose includes:
performing reverse compensation on the roll angle of the target pose according to a preset compensation ratio.

In some embodiments, the pose stabilization processing further includes performing filtering processing on the target pose.

In some embodiments, the filtering processing adopts any one of the following filtering modes: Bayesian filtering, wavelet filtering, Kalman filtering, Wiener filtering, Butterworth filtering, Chebyshev filtering, B-spline fitting or multiple fitting.

In some embodiments, the performing filtering processing on the target pose includes:
filtering a pitch angle and/or yaw angle of the target pose.

In some embodiments, the method further includes:
rendering the virtual scene based on the first predicted pose at the time t+m to obtain a first rendering result;
the performing screen recording on a rendering result of a virtual scene based on the stabilized pose to obtain a screen recording image at a time corresponding to the target pose includes;
performing screen recording based on the stabilized pose and the first rendering result to obtain a screen recording image at the time corresponding to the target pose.

In some embodiments, the performing screen recording based on the stabilized pose and the first rendering result to obtain a screen recording image at the time corresponding to the target pose includes:
warping the first rendering result based on the stabilized pose to obtain a first warp result;
capturing the first warp result to obtain a screen recording image at the time corresponding to the target pose.

In some embodiments, the method further includes:
acquiring a pose of the XR device at time t+n, and predicting a second predicted pose of the XR device at the time t+m based on the pose at the time t+n, where the value of n is less than m;
warping the first rendering result based on the second predicted pose to obtain a second warp result, capturing the second warp result at the time t+m and then displaying it on screen.

In some embodiments, the performing screen recording on a rendering result of a virtual scene based on the stabilized pose to obtain a screen recording image at a time corresponding to the target pose includes:
rendering the virtual scene based on the stabilized pose to obtain a second rendering result;
capturing the second rendering result to obtain a screen recording image at the time corresponding to the target pose.

In some embodiments, the method further includes:
rendering the virtual scene based on the first predicted pose at the time t+m to obtain a first rendering result;
acquiring a pose of the XR device at time t+n, and predicting a second predicted pose of the XR device at the time t+m based on the pose at the time t+n, where the value of n is less than m;
warping the rendering result at the time t+m based on the second predicted pose to obtain a second warp result, capturing the second warp result at the time t+m and then displaying it on screen.

In some embodiments, the rendering the virtual scene based on the stabilized pose to obtain a second rendering result includes:
locally rendering the virtual scene based on the stabilized pose to obtain the second rendering result.

In some embodiments, the rendering the virtual scene based on the first predicted pose at the time t+m to obtain a first rendering result includes:
globally rendering the virtual scene based on the first predicted pose to obtain the first rendering result.

In a second aspect, an embodiment of the present application provides a screen recording apparatus of an extended reality device, which includes:
a pose acquisition module for acquiring a target pose corresponding to an extended reality XR device at time t, wherein the target pose is a pose at the time t or a first predicted pose at time t+m;
a stabilization processing module for performing pose stabilization processing on the target pose to obtain a stabilized pose, wherein the pose stabilization processing comprises performing reverse compensation on a roll angle of the target pose;
a screen recording module for performing screen recording on a rendering result of a virtual scene based on the stabilized pose to obtain a screen recording image at a time corresponding to the target pose, and storing the screen recording image.

In a third aspect, an embodiment of the present application provides an XR device, which comprises: a processor and a memory, wherein the memory is used for storing a computer program, and the processor is used for calling and operating the computer program stored in the memory to execute the method according to any one of the above.

In a fourth aspect, an embodiment of the present application provides a computer-readable storage medium, which is used for storing a computer program that causes a computer to execute the method according to any one of the above.

In a fifth aspect, an embodiment of the present application provides a computer program product, comprising a computer program which, when executed by a processor, implements the method according to any one of the above.

The screen recording method and apparatus of the extended reality device, the device, the medium, and the program provided by the embodiments of the present application comprise: acquiring a target pose corresponding to an XR device at time t, wherein the target pose is a pose at the time t or a first predicted pose at time t+m; performing pose stabilization processing on the target pose to obtain a stabilized pose, wherein the pose stabilization processing comprises performing reverse compensation on a roll angle of the target pose; performing screen recording on a rendering result of a virtual scene based on the stabilized pose to obtain a screen recording image at a time corresponding to the target pose, and storing the screen recording image.

### BRIEF DESCRIPTION OF THE DRAWINGS

In order to explain the technical solutions in the embodiments of the present disclosure more clearly, the drawings needed in the description of the embodiments will be briefly introduced below. Obviously, the drawings in the following description are only some embodiments of the present disclosure. For those skilled in the art, other drawings can be obtained according to these drawings without inventive effort.

FIG. 1 is a principle schematic diagram of a rendering operation and a screen recording operation of an existing XR device;

FIG. 2 is a flow diagram of the screen recording method of the XR device provided in the first embodiment of the present application;

FIG. 3 is a flow diagram of the screen recording method of the XR device provided in the second embodiment of the present application;

FIG. 4 is a principle schematic diagram of the screen recording method of the XR device provided in the second embodiment of the present application;

FIG. 5 is a flow diagram of the screen recording method of the XR device provided in the third embodiment of the present application;

FIG. 6 is a principle schematic diagram of the screen recording method of the XR device provided in the third embodiment of the present application;

FIG. 7 is a schematic structural diagram of a screen recording apparatus of an extended reality device provided in the fourth embodiment of the present application;

FIG. 8 is a schematic structural diagram of the XR device provided in the fifth embodiment of the present application.

### DETAILED DESCRIPTION

The technical solutions in the embodiments of the present disclosure will be clearly and completely described below with reference to the drawings in the embodiments of the present disclosure. Obviously, the described embodiments are only a portion of the embodiments of the present disclosure, but not all the embodiments. Based on the embodiments in the present disclosure, all the other embodiments obtained by those skilled in the art without inventive effort belong to the protection scope of the present disclosure.

It is to be noted that the terms “first” and “second” in the Description and Claims as well as the above drawings of the present application are used to distinguish similar objects, and are not necessarily used to describe a specific order or sequence. It should be understood that the data so used can be interchanged under appropriate circumstances, so that the embodiments of the present disclosure described herein can be implemented in other orders than those illustrated or described herein. Furthermore, the terms “including” and “having” and any variations thereof are intended to cover non-exclusive inclusion, for example, a process, method, system, product or server that contains a series of steps or units is not necessarily limited to those steps or units explicitly listed, but may include other steps or units not explicitly listed or inherent to the process, method, product or device.

An embodiment of the present application provides a screen recording method of an extended reality device, which can be used for screen recording of an XR device. The XR device includes but is not limited to VR devices, AR devices or MR devices. The method of the present embodiment can be executed by an XR device, or by a server or other device that renders a virtual scene.

VR: the technology of creating and experiencing a virtual world, which generates a virtual environment by computation. It is a kind of multi-source information (the virtual reality mentioned herein includes at least visual perception, in addition, it can also include auditory perception, tactile perception, motion perception, and even taste perception, smell perception, etc.), and implements the blended and interactive simulation of three-dimensional dynamic views and entity behaviors of the virtual environment, so that users can immerse themselves in a simulated virtual reality environment to implement applications in various virtual environments such as maps, games, videos, education, medical care, simulation, collaborative training, sales, assistance in manufacturing, maintenance and repair.

AR: AR scenery refers to a simulated scenery in which at least one virtual object is superimposed on a physical scenery or its representation. For example, an electronic system can have an opaque display and at least one imaging sensor for capturing images or videos of a physical scenery, and these images or videos are representations of the physical scenery. The system combines images or videos with a virtual object and displays the combination on an opaque display. Individuals use the system to indirectly view the physical scenery via the images or videos of the physical scenery, and observe the virtual object superimposed on the physical scenery. When the system uses one or more image sensors to capture images of the physical scenery and uses those images to present an AR scenery on the opaque display, the displayed images are referred to as video transparent transmission. Alternatively, the electronic system for displaying the AR scenery can have a transparent or translucent display through which individuals can directly view the physical scenery. The system can display a virtual object on the transparent or translucent display, so that individuals can use the system to observe the virtual object superimposed on the physical scenery. As another example, the system can include a projection system that projects a virtual object into the physical scenery. The virtual object can be projected, for example, on a physical surface or as a hologram, so that individuals use the system to observe the virtual object superimposed on the physical scenery. Specifically, in the process of collecting images by a camera, a technology of computing, in real time, the camera attitude parameters of the camera in the real world (or the three-dimensional world or the real world) and adding virtual elements to the images collected by the camera based on the camera attitude parameters. The virtual elements include, but are not limited to, images, videos and three-dimensional models. The goal of the AR technology is to connect the virtual world with the real world on a screen for interaction.

MR: by presenting virtual scene information in the real scene, an interactive feedback information loop is set up among the real world, the virtual world and the users to enhance the realism of the user experience. For example, a computer-created sensory input (for example, a virtual object) is integrated with a sensory input from a physical scenery or its representation in a simulated scenery, and in some MR sceneries, the computer-created sensory input can adapt to changes of the sensory input from the physical scenery. In addition, some electronic systems for presenting the MR sceneries can monitor an orientation and/or position relative to the physical scenery to enable virtual objects to interact with real objects, i.e., physical elements from the physical scenery or their representations. For example, the system can monitor movement so that a virtual plant seems stationary relative to a physical building.

A virtual reality device refers to a terminal that implements the virtual reality effect, which can be usually provided in the form of glasses, Head Mount Displays (HMDs) and contact lenses for implementing visual perception and perception in other forms. Certainly, the forms implemented by the virtual reality device are not limited to these, and it can be further miniaturized or enlarged based on actual needs.

Optionally, the virtual reality device (namely the XR device) described in the embodiments of the present application can include but is not limited to the following types:
(1) Mobile virtual reality device, which supports a mobile terminal (such as a smart phone) to be provided in various ways (such as a head mount display provided with special card slots), wherein the mobile terminal performs relevant computations of virtual reality functions and outputs data to the mobile virtual reality device for watching virtual reality videos through an APP of the mobile terminal, for example, through a connection with the mobile terminal in a wired or wireless way;
(2) All-in-one virtual reality device, which is provided with a processor for performing relevant computations of virtual functions, so that it has independent virtual reality input and output functions, without being connected with a PC or a mobile terminal, and it has high freedom of use;
(3) Personal computer VR (PCVR) device, which uses a PC to perform relevant computations of virtual reality functions and data output, wherein an external personal computer VR device uses data output from the PC to implement the virtual reality effects.

The rendering operation of the XR device needs to be based on a pose of the XR device at a display time. The pose of the XR device is 6 dimensions of freedom (DOF) data, including the position and pose of the XR device. The rendering operation of the XR device refers to rendering the virtual scene, which needs to take a certain period of time. Therefore, it is necessary to execute the rendering operation in advance, i.e., in a period of time before the display time, and the pose used for executing the rendering operation in advance is a predicted pose of the XR device at a future display time. The pose of the XR device at the future display time is predicted usually based on the pose of the XR device at the current time, or based on the poses of the XR device at the current time and the previous time.

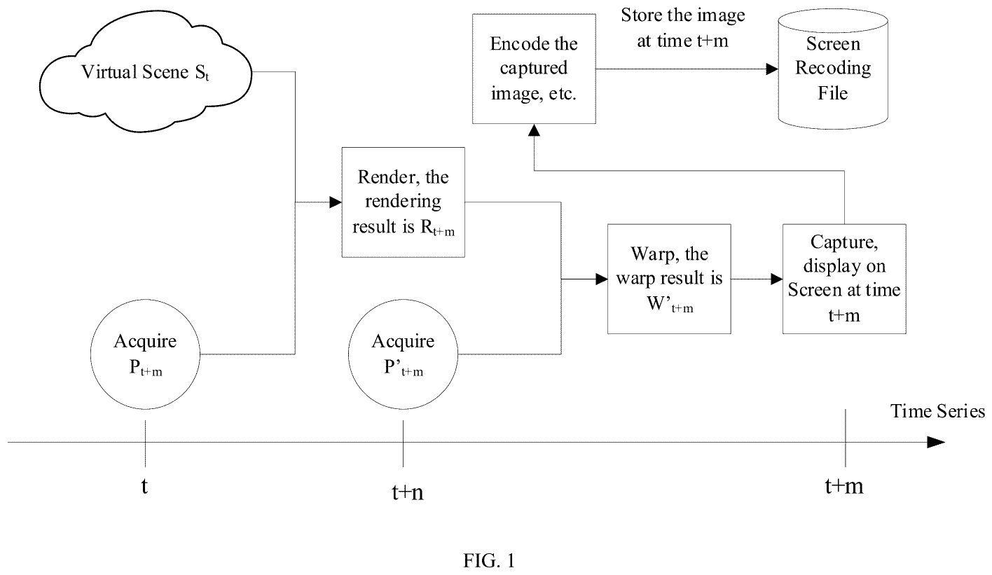

FIG. 1 is a schematic diagram of a rendering operation and a screen recording operation of an existing XR device. As shown in FIG. 1, the XR device starts at time t to render the image displayed at time t+m. Relative to time t, time t+m is displayed as a future display time, that is, the XR device executes the rendering operation m times in advance. The pose used for executing the rendering operation in advance is a pose at time t+m (represented as Pₜ₊ₘ) which is predicted based on the pose of the XR device at the current time. After the Pₜ₊ₘ is predicted, the virtual scene is rendered based on the Pₜ₊ₘ to obtain a rendering result (represented as Rₜ₊ₘ).

Because the pose used for rendering is not the real pose at time t+m but the pose predicted in advance, the predicted pose result is not accurate. Thus, after the rendering is ended, the XR device re-predicts a pose (P′t+m) of the XR device at time t+m according to the pose at the end time of the rendering (represented as t+n). The real pose of the XR device at a certain time refers to the pose of the XR device detected by a positioning module of the XR device.

According to the time-series relationship shown in FIG. 1, time t+n is closer to time t+m, so the accuracy of the predicted P′ₜ₊ₘ is higher than that of Pₜ₊ₘ. Before on-screen display, the XR device uses P′ₜ₊ₘ to warp the previous rendering result Rₜ₊ₘ, and the warp result is W′ₜ₊ₘ. After the warp result W′1+m is captured (or referred to as clipped), it is displayed on screen at time t+m.

An existing screen recording function is to encode an image displayed on screen and then store it, that is, the data obtained by capturing the warp result W′ₜ₊ₘ is used for the on-screen display in one way and for storage after encoding in the other way. In the process of using the XR device, any head rotation of users will cause the picture displayed by the XR device to follow the change. When the user's head jitters frequently, the picture displayed by the XR device and the screen recording picture will jitter accordingly, so that the screen recording picture obtained by screen recording jitters greatly and the screen recording quality is low. It leads to a serious sense of dizziness when users watch the screen recording picture, and the user experience is not good.

The time unit of the time series shown in FIG. 1 is millisecond (ms). There is a difference of m milliseconds from time t to time t+m and a difference of n milliseconds from time t to time t+n. It can be understood that the time unit can also be smaller than millisecond, for example, the time unit can be microsecond.

In order to solve the existing technical problem, an embodiment of the present application provides a screen recording method of an extended reality device, which performs pose stabilization processing on the pose of the XR device, and uses the stabilized pose to perform screen recording on the rendering result of the virtual scene, so that the screen recording picture is more stable without obvious sense of jitter, thus reducing the sense of dizziness when uses watch the screen recording picture.

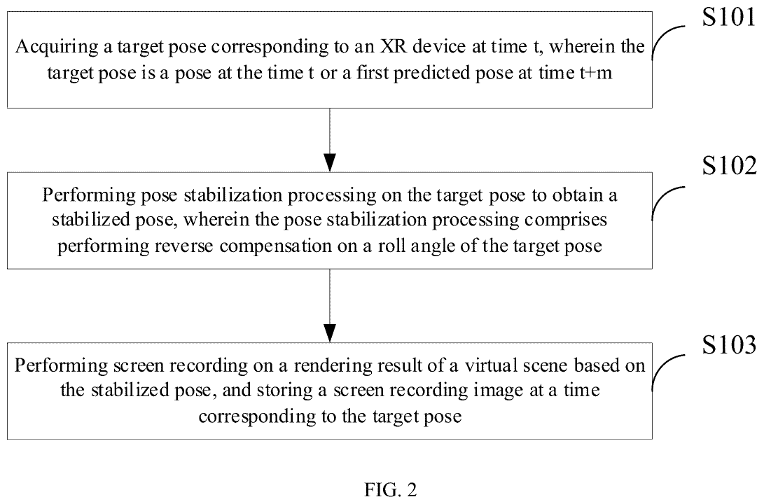

The screen recording method of the XR device provided by the embodiment of the present application will be described in combination with the time-series relationship shown in FIG. 1. FIG. 2 is a flow diagram of the screen recording method of the XR device provided in the first embodiment of the present application, and the method of the present embodiment can be executed by the XR device. As shown in FIG. 2, the method provided by the present embodiment includes the following steps.
S101, acquiring a target pose corresponding to an XR device at time t, wherein the target pose is a pose at the time t or a first predicted pose at time t+m.

The pose at time t is a pose positioned by a positioning module of the XR device, and is the actual pose of the XR device. The t+m is a future time after time t. It is impossible to acquire the actual pose at time t+m by the positioning module of the XR device at time t, and it is necessary to predict the pose of the XR device at time t+m based on the measured actual pose. The predicted pose of the XR device at time t+m is referred to as a first predicted pose.

The XR device can predict the pose at time t+m based on the pose at time t, and can also predict the pose at time t+m based on the pose at time t and the poses at multiple times before time t. Illustratively, it is possible to predict the pose at time t+m by using a neural network model, or determine the pose at time t+m by means of fitting. This is just an example, and other method can also be used to predict the pose at time t+m, which is not limited by the embodiment of the present application.

Taking the neural network model as an example, the pose at time t, or the pose at time t and the poses at multiple times before time t are input into the neural network model, and the output of the neural network model is the first predicted pose at time t+m.

Optionally, the positioning module includes but is not limited to visual Synchronous Localization and Mapping (SLAM) modules, Inertial Measurement Units (IMUs), gyroscopes, lasers, accelerometers, infrared sensors and the like. The SLAM module can perform positioning based on the images shot by the camera module and the IMU data.

In the present embodiment, the time unit can be millisecond, and the difference between time t and time t+m is m milliseconds. The time unit can also be a unit smaller than millisecond, for example, the time unit can be microsecond.
S102, performing pose stabilization processing on the target pose to obtain a stabilized pose, wherein the pose stabilization processing comprises performing reverse compensation on a roll angle of the target pose.

The pose of the XR device includes position and attitude, wherein, the position refers to values of the XR device on X, Y and Z axes, the attitude refers to rotation angles of the XR device on X, Y and Z axes. The pose of the XR device includes three angles: a yaw angle, a pitch angle and a roll angle, wherein, the angle of rotation around the X axis is called the pitch angle, the angle of rotation around the Y axis is called the yaw angle, the angle of rotation around the Z axis is called the roll angle, and the roll angle is also referred to as a horizontal roll angle. In general, when users wear the XR device, the horizontal direction is the X-axis direction, the vertical direction (i.e. gravity direction) is the Y-axis direction, and the front-back direction is the Z-axis direction.

The rotation of the roll angle has a great influence on the jitter of the screen recording screen. Therefore, in the present embodiment, reverse compensation is performed on the roll angle of the target pose. The reverse compensation means performing compensation in the opposite direction of the rotation direction of the roll angle, so as to reduce the rotation angle of the roll angle of the target pose and make changes of the target pose for screen recording relatively smooth.

Illustratively, it is possible to perform reverse compensation on the roll angle of the target pose in the following modes.

In a first implementation, reverse compensation is performed on the roll angle of the target pose, so that a value of the roll angle of the target pose after reverse compensation is a preset value.

The preset value can be 0 or other values, for example, in some scenes, the preset value is set to 90 degrees. In this mode, no matter how the XR device rotates after the start of screen recording, the value of the roll angle of the XR device is the preset value, that is, the roll angle of the XR device remains unchanged all the time, thus reducing the jitter of the screen recording picture.

The preset value of 0 means that the rotation angle of the roll angle is 0, in other words, the rotation angle of the roll angle of the XR device from the last time to the current time is 0, that is, the XR device does not rotate on the Z axis. In this mode, no matter how the XR device rotates after the start of screen recording, the value of the roll angle of the XR device is 0, that is, the roll angle of the XR device remains unchanged all the time, thus reducing the jitter of the screen recording picture.

In a second implementation, when the roll angle of the target pose is greater than or equal to a preset angle threshold, reverse compensation is performed on the roll angle of the target pose, so that the value of the roll angle of the target pose after reverse compensation is the preset value.

The preset value can be 0 or other values, and the value of the angle threshold should be such that when the roll angle of the target pose is less than the preset angle threshold, the rotation of the roll angle has no or little influence on the jitter of the screen recording picture. Therefore, in this mode, when the roll angle of the target pose is less than the preset angle threshold, reverse compensation is not performed on the roll angle of the target pose. Only when the roll angle of the target pose is greater than or equal to the angle threshold, reverse compensation is performed on the roll angle of the target pose, and the value of the roll angle of the target pose after reverse compensation is the preset value. Illustratively, the angle threshold is 1 degree, 2 degrees or 5 degrees, etc.

In a third implementation, when the roll angle of the target pose is greater than or equal to the preset angle threshold, reverse compensation is performed on the roll angle of the target pose, so that the value of the roll angle of the target pose after reverse compensation is the angle threshold.

Illustratively, the angle threshold is 1 degree, 2 degrees or 5 degrees, etc. When the roll angle of the target pose is greater than or equal to the preset angle threshold, by reversely compensating the value of the roll angle of the target pose to the angle threshold, a jump of the screen recording picture caused by a too large angle of reverse compensation can be avoided, thus making the screen recording picture more continuous and stable.

In a fourth implementation, when the roll angle of the target pose is greater than or equal to the preset angle threshold, reverse compensation is performed on the roll angle of the target pose according to a preset compensation angle.

In this mode, compensation is performed according to a preset compensation angle, and the compensation angle can be less than, greater than or equal to a preset angle threshold. Illustratively, the compensation angle is 2 degrees, 3 degrees or 5 degrees, and the value of the roll angle of the target pose after compensation in this mode may or may not be 0.

In a fifth implementation, reverse compensation is performed on the roll angle of the target pose according to a preset compensation ratio.

In this mode, reverse compensation is performed according to a preset compensation ratio, and the compensation ratio is greater than 0 and less than 1. Illustratively, the compensation ratio is ½ or ⅔. When the value of the roll angle of the target pose is 6 and the compensation ratio is ⅔, the reverse compensation angle is 6*(⅔)=4, and the roll angle after reverse compensation is 2.

The above implementations are just examples, and the present embodiment can also perform reverse compensation in other modes. The value of the roll angle after reverse compensation is reduced.

Optionally, the pose stabilization processing further includes performing filtering processing on the target pose, and smoothing the target pose through the filtering processing, so that the change of the stabilized pose is smoother. The filtering processing is also referred to as low-pass filtering, and can be performed in any existing filtering mode, which is not limited in the present embodiment.

The filtering processing adopts any one of the following filtering modes: Bayesian filtering, wavelet filtering, kalman filtering, Wiener filtering, Butterworth filtering, Chebyshev filtering, B-spline fitting or multiple fitting. The filtering parameters can be adjusted according to the actual use of different scenes and devices, so that the filtering effect can reach the users' expectation.

Optionally, it is possible to perform filtering processing on the target pose first, and then perform reverse compensation on the roll angle after filtering processing, or perform reverse compensation on the roll angle of the target pose first, and then perform filtering processing on the target pose after reverse compensation.

Optionally, when filtering the target pose or the target pose after reverse compensation, it is possible to filter only the yaw angle and/or pitch angle of the target pose or the target pose after reverse compensation, instead of the roll angle.

Optionally, the roll angle of the stabilized pose is a preset value, and the preset value can be 0, for example. For example, when filtering only the yaw angle and/or pitch angle of the target pose instead of the roll angle, since the value of the roll angle of the target pose after reverse compensation is the preset value, and accordingly, the value of the roll angle of the stabilized pose is the preset value.
S103, according to the stabilized pose, performing screen recording on a rendering result of a virtual scene, and storing a screen recording image at a time corresponding to the target pose.

In the embodiment of the present application, the rendering operation and on-screen display of the XR device can still be performed in the existing modes, and only the screen recording flow is improved. Therefore, the screen recording flow is mainly described in the present embodiment.

In one implementation, a first rendering result corresponding to time t+m is warped based on the stabilized target pose to obtain a first warp result, and the first warp result is captured to obtain a screen recording image at the time corresponding to the target pose. The first rendering result is a rendering result obtained by rendering the virtual scene by the XR device based on the first predicted pose at time t+m.

Warping the first rendering result can be understood as revising or correcting the first rendering result. This is because the stabilized pose has changed relative to the first predicted pose used for rendering the first rendering result, and the rendering result will also change accordingly after the pose change. However, re-rendering needs a long time, while the warp operation is a 2D operation, and the warp operation takes a short time. Therefore, the warp operation is used to correct the first rendering result, and the corrected rendering result (i.e. the first warp result) matches the stabilized pose.

Optionally, the XR device can use Asynchronous Timewarp (ATW) or Asynchronous Spacewarp (ASW) to warp the first rendering result.

A first warp result obtained by warping the first rendering result is a spherical scene, but the picture that can be displayed by a display of the XR device (namely the picture that can be seen from the user's perspective) is only a portion of the spherical scene. Therefore, a one-frame image can be captured from the spherical scene as a screen recording image based on the size of the displayed picture, and the XR device encodes the captured screen recording image and then stores it.

In another implementation, the virtual scene is rendered based on the stabilized pose to obtain a second rendering result, and the second rendering result is captured to obtain a screen recording image at the time corresponding to the target pose.

In this implementation, two rendering ways are needed. One rendering way is used for normal on-screen display, which can refer to the rendering operation and on-screen process shown in FIG. 1. The other rendering way is used for screen recording, and the virtual scene is rendered based on the stabilized pose to obtain a second rendering result, which is used to obtain a screen recording image, and the screen recording image is stored.

Optionally, before the XR device stores the screen recording image, it encodes (or other operation) the screen recording image into a required format, and correspondingly, when playing the screen recording image, it decodes the screen recording image and then plays it. The XR device can store the screen recording image locally, specifically, it can store the screen recording image on a disk or hard disk, or in a memory first.

Optionally, the XR device can also store the screen recording image on other devices. For example, the XR device stores the encoded screen recording image in a mobile phone or computer connected to the XR device.

It can be understood that the present embodiment takes the screen recording of a single-frame image as an example. In the XR scene, usually, a multiple-frame image is continuously captured, and the continuously captured screen recording image can be encoded and then stored as a screen recording video, and subsequently users can view the stored screen recording video.

In the present embodiment, the target pose corresponding to the XR device at time t is acquired, and the target pose is the pose at time t or the first predicted pose at time t+m. The pose stabilization processing is performed on the target pose to obtain the stabilized pose, and the pose stabilization processing includes: performing reverse compensation on a roll angle of the target pose; performing screen recording on a rendering result of a virtual scene based on the stabilized pose to obtain a screen recording image at a time corresponding to the target pose, and storing the screen recording image. By performing reverse compensation on the roll angle of the target pose, the shake of the XR device in a roll direction corresponding to the roll angle is further reduced, thus reducing the jitter of the screen recording picture and improving the screen recording quality.

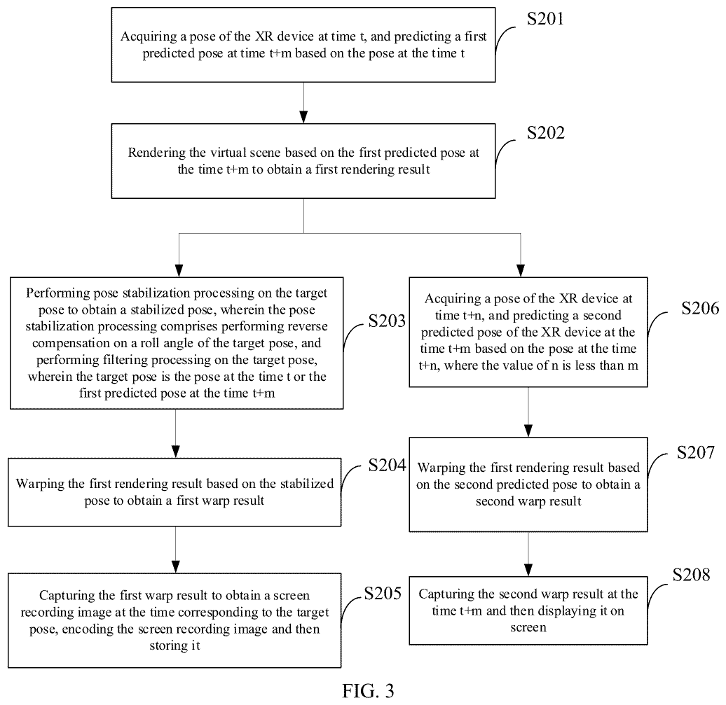

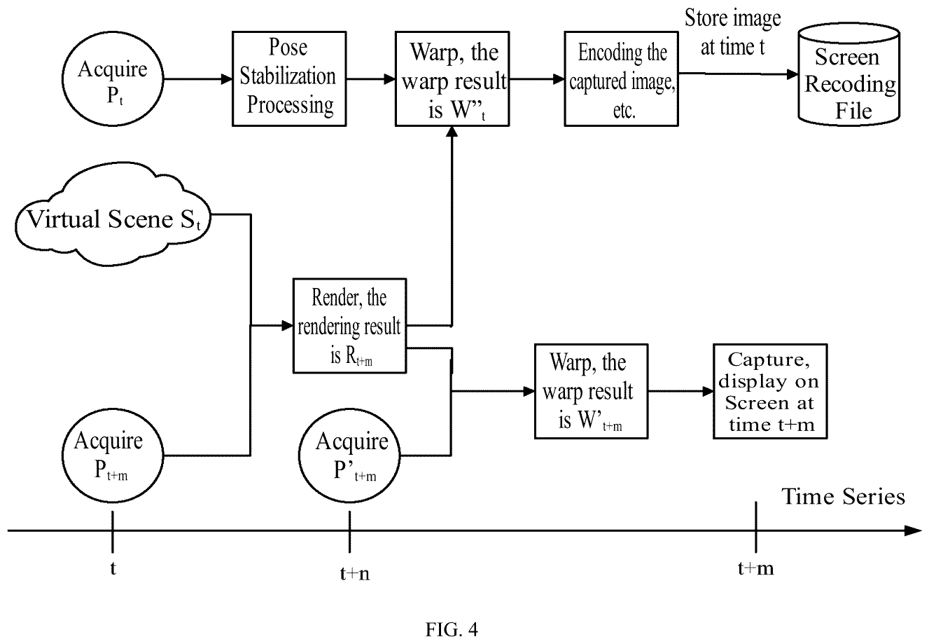

On the basis of the first embodiment, the second embodiment of the present application provides a screen recording method of an XR device. In the present embodiment, the virtual scene is rendered in one way. The screen recording flow and the on-screen flow use different poses to warp the rendering result, and the screen recording flow uses the stabilized pose to warp the rendering result. FIG. 3 is a flow diagram of the screen recording method of the XR device provided in the second embodiment of the present application, and FIG. 4 is a principle schematic diagram of the screen recording method of the XR device provided in the second embodiment of the present application. Referring to FIGS. 3 and 4, the method provided in the present embodiment includes the following steps.
S201, acquiring a pose of the XR device at time t, and predicting a first predicted pose at time t+m based on the pose at the time t.

Referring to FIG. 4, the pose at time t is expressed as Pₜ, and the first predicted pose at time t+m is expressed as Pₜ₊ₘ. The XR device detects the pose at time t through its own positioning module at time t, and predicts the first predicted pose at time t+m based on the pose at time t.
S202, rendering the virtual scene based on the first predicted pose at the time t+m to obtain a first rendering result.
S203, performing pose stabilization processing on the target pose to obtain a stabilized pose, wherein the pose stabilization processing comprises performing reverse compensation on a roll angle of the target pose, and performing filtering processing on the target pose, wherein the target pose is the pose at the time t or the first predicted pose at the time t+m.

In FIG. 4, the target pose being the pose at time t is taken as an example to explain. Referring to FIGS. 4, S202 and S203 are executed in any order, or can be executed at the same time. The first rendering result obtained by rendering in step S202 is the rendering result Rₜ₊ₘ in FIG. 4.

The specific flow of the pose stabilization processing refers to the related description of the first embodiment, and will not be described here.
S204, warping the first rendering result based on the stabilized pose to obtain a first warp result.
S205, capturing the first warp result to obtain a screen recording image at the time corresponding to the target pose, and encoding the screen recording image and then storing it.

In FIG. 4, the target pose being the pose at time t is taken as an example to explain. The first warp result obtained in step S204 is W″t in FIG. 4, and correspondingly, the screen recording result is a screen recording image at time t, which is encoded (or other operation) and stored in a screen recording file.

In the present embodiment, after the first rendering result is obtained, screen recording is performed based on the stabilized pose and the first rendering result to obtain a screen recording image at the time corresponding to the target pose. In one implementation, the screen recording operation is performed through the above steps S204 and S205. Optionally, in other implementations, it is also possible to warp a recording frame based on the stabilized pose to obtain a target recording frame, and use the target recording frame to capture the first rendering result to obtain the screen recording image at the time corresponding to the target pose.

Step S206, acquiring a pose of the XR device at time t+n, and predicting a second predicted pose of the XR device at the time t+m based on the pose at the time t+n, where the value of n is less than m.

The pose of the XR device at time t+n is a pose detected by a positioning module of the XR device, and the value of n is less than m, that is, time t+n is a time before time t+m. The time t+n is a time corresponding to the warp operation before the on-screen display, which is between the rendering end time and the on-screen time, and may be equal to or later than the rendering end time.

The second predicted pose at time t+m can be predicted based on the pose at time t+n, and the prediction method of the second predicted pose is the same as that of the first predicted pose, which will not be described here.
S207, warping the first rendering result based on the second predicted pose to obtain a second warp result.
S208, capturing the second warp result at the time t+m and then displaying it on screen.

Referring to FIG. 4, the second predicted pose at time t+m is P′ₜ₊ₘ in FIG. 4, and the second warp result is W′ₜ₊ₘ in FIG. 4. At time t+m, the second warp result is captured based on the size of the display screen to obtain the displayed image at time t+m, and the displayed image at time t+m is displayed on screen. Referring to the time-series relationship shown in FIG. 4, it can be seen that steps S203-S205 are executed in parallel with steps S206-S208.

In the present embodiment, the stabilized pose is obtained by performing pose stabilization processing on the target pose, the first rendering result at time t+m is warped by using the stabilized pose to obtain a first warp result, the first warp result is captured to obtain a screen recording image at the time corresponding to the target pose, and the screen recording image is encoded and then stored. The stabilized pose is smoother, which eliminates or greatly reduces the jitter in a horizontal roll direction, thereby reducing the jitter of the screen recording picture.

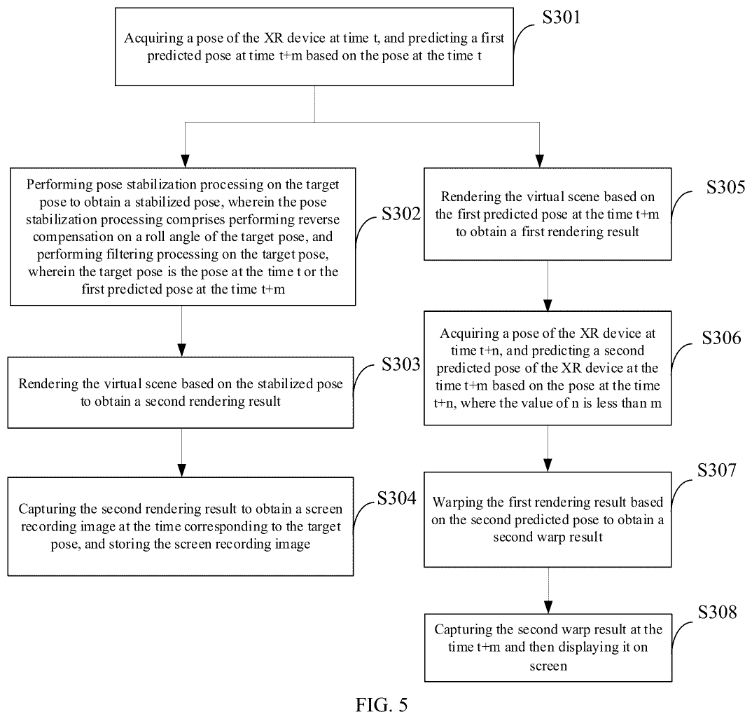

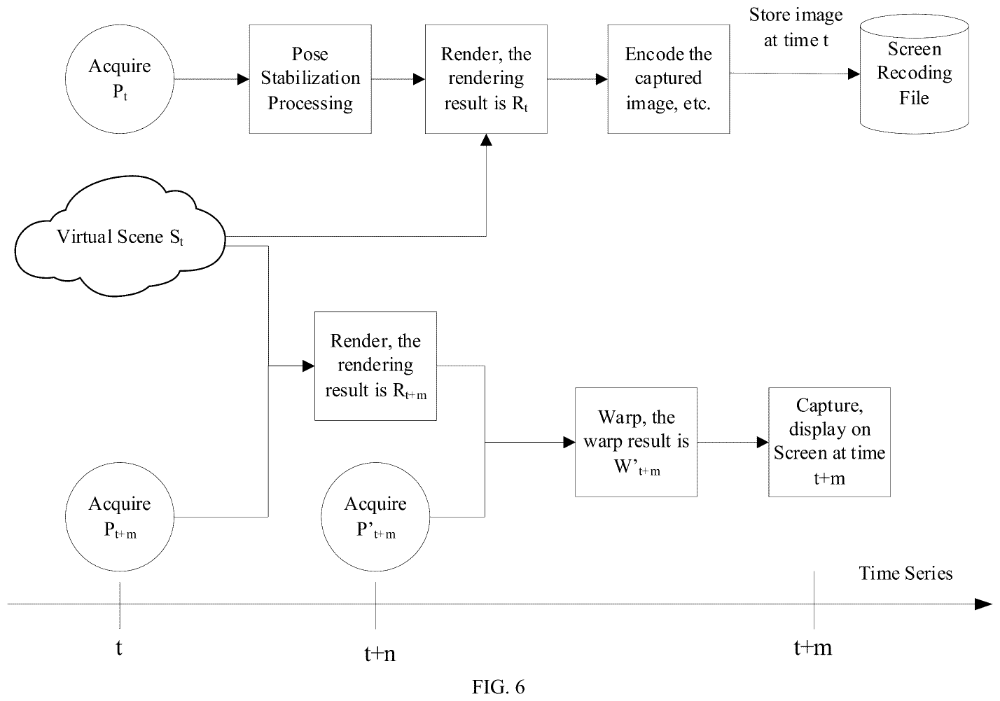

On the basis of the first embodiment, the third embodiment of the present application provides a screen recording method of an XR device. In the present embodiment, the virtual scene is rendered in two ways, the rendering result of one way is used for on-screen display, and the rendering result of the other way is used for screen recording. The screen recording flow adopts the pose after stabilization processing for rendering. FIG. 5 is a flow diagram of the screen recording method of the XR device provided in the third embodiment of the present application, and FIG. 6 is a principle schematic diagram of the screen recording method of the XR device provided in the third embodiment of the present application. Referring to FIGS. 5 and 6, the method provided in the present embodiment includes the following steps.
S301, acquiring a pose of the XR device at time t, and predicting a first predicted pose at time t+m based on the pose at the time t.
S302, performing pose stabilization processing on the target pose to obtain a stabilized pose, wherein the pose stabilization processing comprises performing reverse compensation on a roll angle of the target pose, and performing filtering processing on the target pose, wherein the target pose is the pose at the time t or the first predicted pose at the time t+m.
S303, rendering the virtual scene based on the stabilized pose to obtain a second rendering result.
S304, capturing the second rendering result to obtain a screen recording image at the time corresponding to the target pose, and storing the screen recording image.

Referring to FIG. 6, the target pose being the pose at time t in FIG. 6 is taken as an example to explain. Accordingly, the second rendering result obtained in step S303 is Rₜ in FIG. 6, and the screen recording result is a screen recording image at time t, which is encoded (or other operation) and then stored in a screen recording file.
S305, rendering the virtual scene based on the first predicted pose at the time t+m to obtain a first rendering result.
S306, acquiring a pose of the XR device at time t+n, and predicting a second predicted pose of the XR device at the time t+m based on the pose at the time t+n, where the value of n is less than m.
S307, warping the first rendering result based on the second predicted pose to obtain a second warp result.
S308, capturing the second warp result at the time t+m and then displaying it on screen.

Referring to FIG. 6, the second predicted pose at time t+m is P′ₜ₊ₘ in FIG. 4, and the second warp result is W′ₜ₊ₘ in FIG. 6. At time t+m, the second warp result is captured based on the size of the display screen to obtain the displayed image at time t+m, and the displayed image at time t+m is displayed on screen. Referring to the time-series relationship shown in FIG. 6, it can be seen that steps S302-S304 are executed in parallel with steps S305-S308.

In the present embodiment, the screen recording flow and the on-screen flow perform rendering separately, wherein the rendering result for screen recording does not need to be warped, and the stabilized pose is used for rendering to obtain a second rendering result, and the second rendering result is directly captured, encoded and stored (and other operations). Because the second rendering result for screen recording does not need to be warped, when the virtual scene is rendered, optionally, the virtual scene can be locally rendered based on the stabilized pose to obtain the second rendering result.

Local rendering is relative to global rendering. The global rendering refers to the rendering of a spherical area centered on the pose of the XR device, that is, the rendering result is a spherical scene. In contrast, a rendering area that is locally rendered is smaller than the spherical rendering area, and only the hemispherical area, ¼ spherical area, ⅓ spherical area, ½ spherical area, etc. can be rendered. In the present embodiment, the size of the local rendering area is not limited, and the size of the local rendering area is larger than or equal to that of the display area of the XR device.

It can be understood that the larger the rendering area, the greater the resources and duration required for rendering, and the smaller the rendering area, the smaller the resources and duration required for rendering. Compared with global rendering, local rendering can save computing resources and reduce rendering duration.

In the present embodiment, the screen recording flow can adopt local rendering, and the on-screen flow can adopt global rendering, thus saving computing resources for rendering and reducing power consumption of the XR device.

Optionally, in one implementation, both the screen recording flow and the on-screen flow can adopt global rendering, which is not limited in the present embodiment.

In the present embodiment, by performing the pose stabilization processing on the target pose, the virtual scene is rendered by using the obtained stabilized pose to obtain a second rendering result, and the second rendering result is captured to obtain a screen recording image at the time corresponding to the target pose, and the screen recording image is encoded and then stored. The stabilized pose is smoother relative to the target pose, which eliminates and greatly reduces the jitter in a horizontal roll direction, thereby reducing the jitter of the screen recording picture.

It should be noted that the target pose used for screen recording in FIG. 4 and FIG. 6 is the actual pose at time t. In other embodiments of the present application, this target pose can also be replaced by the first predicted pose at time t+m. No matter whether the pose at time t or the first predicted pose at time t+m is adopted as the target pose, the screen recording flow and principle are the same, and the description is not repeated here.

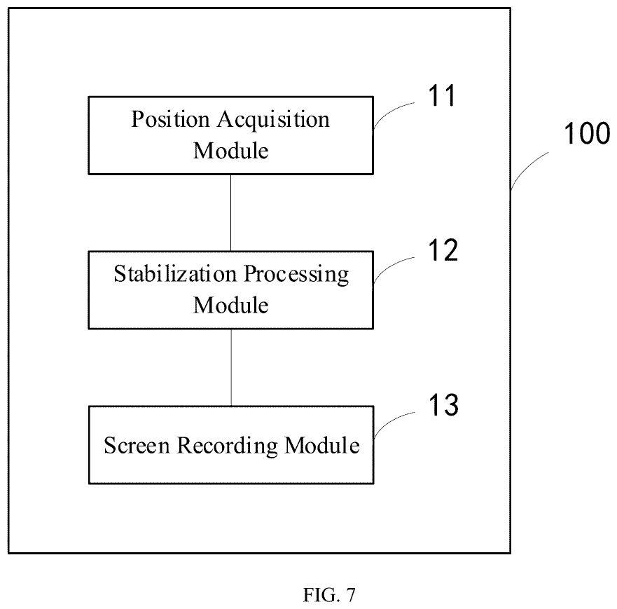

In order to better implement the screen recording method of the extended reality device of the embodiment of the present application, an embodiment of the present application further provides a screen recording device of an extended reality device. FIG. 7 is a schematic structural diagram of a screen recording apparatus of an extended reality device provided in the fourth embodiment of the present application. As shown in FIG. 7, a screen recording device 100 of the extended reality device can include:
a pose acquisition module 11 for acquiring a target pose corresponding to an extended reality XR device at time t, wherein the target pose is a pose at the time t or a first predicted pose at time t+m;
a stabilization processing module 12 for performing pose stabilization processing on the target pose to obtain a stabilized pose, wherein the pose stabilization processing comprises performing reverse compensation on a roll angle of the target pose;
a screen recording module 13 for performing screen recording on a rendering result of a virtual scene based on the stabilized pose to obtain a screen recording image at a time corresponding to the target pose, and storing the screen recording image.

In some embodiments, the stabilization processing module 12 is specifically used for:
performing reverse compensation on the roll angle of the target pose, so that a value of the roll angle of the target pose after reverse compensation is a preset value.

In some embodiments, the stabilization processing module 12 is specifically used for:
when the roll angle of the target pose is greater than or equal to a preset angle threshold, performing reverse compensation on the roll angle of the target pose, so that a value of the roll angle of the target pose after reverse compensation is a preset value or the angle threshold;
or, when the roll angle of the target pose is greater than or equal to a preset angle threshold, performing reverse compensation on the roll angle of the target pose according to a preset compensation angle.

In some embodiments, the stabilization processing module 12 is specifically used for:
performing reverse compensation on the roll angle of the target pose according to a preset compensation ratio.

In some embodiments, the pose stabilization processing further includes: performing filtering processing on the target pose.

In some embodiments, the filtering processing adopts any one of the following filtering modes: Bayesian filtering, wavelet filtering, Kalman filtering, Wiener filtering, Butterworth filtering, Chebyshev filtering, B-spline fitting or multiple fitting.

In some embodiments, the performing filtering processing on the target pose includes:
filtering a pitch angle and/or yaw angle of the target pose.

In some embodiments, the apparatus further includes a rendering module;
wherein the rendering module is used for rendering the virtual scene based on the first predicted pose at the time t+m to obtain a first rendering result;
the screen recording module 13 is specifically used for performing screen recording based on the stabilized pose and the first rendering result to obtain a screen recording image at the time corresponding to the target pose.

In some embodiments, the screen recording module 13 is specifically used for: warping the first rendering result based on the stabilized pose to obtain a first warp result;
capturing the first warp result to obtain a screen recording image at the time corresponding to the target pose.

In some embodiments, the apparatus further includes an on-screen module;
the pose acquisition module 11 is further used for acquiring a pose of the XR device at time t+n, and predicting a second predicted pose of the XR device at the time t+m based on the pose at the time t+n, where the value of n is less than m;
the on-screen module is used for warping the first rendering result based on the second predicted pose to obtain a second warp result, and capturing the second warp result at the time t+m and then displaying it on screen.

In some embodiments, the screen recording module 13 is specifically used for:
rendering the virtual scene based on the stabilized pose to obtain a second rendering result;
capturing the second rendering result to obtain a screen recording image at the time corresponding to the target pose.

In some embodiments, the apparatus further includes a rendering module and an on-screen module;
wherein the rendering module is used for rendering the virtual scene based on the first predicted pose at the time t+m to obtain a first rendering result;
the pose acquisition module 11 is further used for acquiring a pose of the XR device at time t+n, and predicting a second predicted pose of the XR device at the time t+m based on the pose at the time t+n, where the value of n is less than m;
the on-screen module is used for warping the first rendering result based on the second predicted pose to obtain a second warp result, and capturing the second warp result at the time t+m and then displaying it on screen.

In some embodiments, the screen recording module 13 is specifically used for locally rendering the virtual scene based on the stabilized pose to obtain the second rendering result.

In some other embodiments, the screen recording module 13 is specifically used for globally rendering the virtual scene based on the first predicted pose to obtain the first rendering result.

It should be understood that the apparatus embodiment and the method embodiment can correspond to each other, and a similar description can refer to the method embodiment. In order to avoid repetition, details will not be described here.

The apparatus 100 of the embodiment of the present application has been described above from the perspective of functional modules in combination with the drawings. It should be understood that the functional modules can be implemented by hardware, or by instructions in the form of software, or by a combination of hardware and software modules. Specifically, the steps of the method embodiment of the embodiments of the present application can be achieved by integrated logic circuits of hardware and/or instructions in the form of software in the processor, and the steps of the method disclosed in combination with the embodiment of the present application can be directly embodied as being executed by the hardware decoding processor or as being executed by the combination of hardware and software modules in the decoding processor. Optionally, the software module can be located in a mature storage medium in the art such as random access memory, flash memory, read-only memory, programmable read-only memory, electrically erasable programmable memory, or register. The storage medium is located in the memory, and the processor reads information in the memory and achieves the steps in the above method embodiment in combination with its hardware.

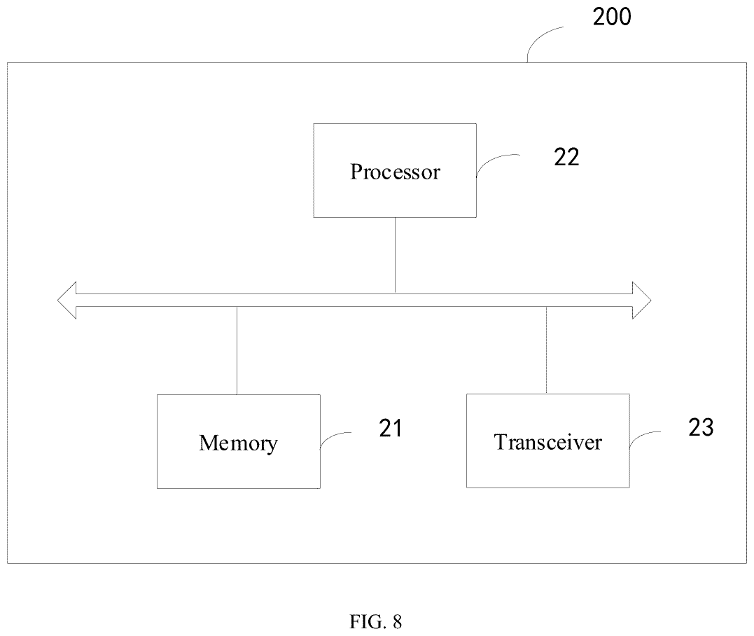

An embodiment of the present application further provides an XR device. FIG. 8 is a schematic structural diagram of an XR device provided in the fifth embodiment of the present application. As shown in FIG. 8, the XR device 200 can include:
a memory 21 and a processor 22, wherein the memory 21 is used for storing a computer program and transmitting the program codes to the processor 22. In other words, the processor 22 can call and operate the computer program from the memory 21 to implement the method in the embodiment of the present application.

For example, the processor 22 can be used for executing the above method embodiment according to the instructions in the computer program.

In some embodiments of the present application, the processor 22 can include, but is not limited to, a general-purpose processor, a Digital Signal Processor (DSP), an Application Specific Integrated Circuit (ASIC), Field Programmable Gate Array (FPGA) or other programmable logic devices, discrete gate or transistor logic devices, discrete hardware components, and so on.

In some embodiments of the present application, the memory 21 includes, but is not limited to, a volatile memory and/or nonvolatile memory. The nonvolatile memory can be a Read-Only Memory (ROM), a Programmable ROM (PROM), an Erasable PROM (EPROM), Electrically EPROM (EEPROM) or a flash memory. The volatile memory can be a Random Access Memory (RAM), which is used as an external cache. By way of illustration, but not limitation, many forms of RAM are available, such as Static RAM (SRAM), Dynamic RAM (DRAM), Synchronous DRAM (SDRAM), Double Data Rate SDRAM (DDR SDRAM), Enhanced SDRAM (ESDRAM), synch link DRAM (ELDRAM), and Direct Rambus RAM (DR RAM).

In some embodiments of the present application, the computer program can be divided into one or more modules, which are stored in the memory 21 and executed by the processor 22 to achieve the method provided by the present application. The one or more modules can be a series of computer program instruction segments that can achieve specific functions, and the instruction segments are used to describe the execution process of the computer program in the XR device.

As shown in FIG. 8, the XR device 200 can further include a transceiver 23 which can be connected to the processor 22 or the memory 21.

The processor 22 can control the transceiver 23 to communicate with other devices, specifically, it can send information or data to other devices, or receive information or data sent from other devices. The transceiver 23 can include a transmitter and a receiver. The transceiver 23 can further include antenna(s), which can comprise one or more antennas.

It can be understood that although not shown in FIG. 8, the XR device 200 can further include a camera module, a wireless fidelity WIFI module, a positioning module, a Bluetooth module, a display, a controller, etc., which will not be described in detail here.

It should be understood that the components in the XR device are connected by a bus system, wherein the bus system includes a power bus, a control bus and a status signal bus in addition to a data bus.

The present application further provides a computer storage medium having a computer program stored thereon, which, when executed by a computer, enables the computer to execute the method of the above method embodiment. In other words, the embodiment of the present application further provides a computer program product containing instructions which, when executed by a computer, cause the computer to execute the method of the above method embodiment.

The present application further provides a computer program product, which includes a computer program stored in a computer-readable storage medium. The processor of the XR device reads the computer program from the computer-readable storage medium, and the processor executes the computer program, so that the XR device executes the corresponding flow in the method embodiment, which is not repeated here for brevity.

In the several embodiments provided by the present application, it should be understood that the revealed system, apparatus and method can be implemented in other ways. For example, the apparatus embodiment described above is only schematic. For example, the division of the module is only a logical function division. In actual implementation, there are other division ways, for example, multiple modules or components can be combined or integrated into another system, or some features can be ignored or not executed. On the other hand, the mutual coupling or direct coupling or communication connection shown or discussed can be made through some interfaces, and the indirect coupling or communication connection of the means or modules can be electrical, mechanical or in other forms.

The modules described as separate components can or can not be physically separated, and the components displayed as modules can or can not be physical modules, that is, they can be located in one place or distributed onto multiple network units. Part or all of the modules can be selected according to actual needs to implement the purpose of the solution of the present embodiment. For example, the functional modules in the embodiments of the present application can be integrated into one processing module, or the modules can exist physically alone, or two or more modules can be integrated into one module.

The above are only the specific implementations of the present application, but the protection scope of the present application is not limited to this. Any skilled in this technical field can easily think of changes or substitutions within the technical scope revealed in the present application, which should be included in the protection scope of the present application. Therefore, the protection scope of the present application should be based on the protection scope of the claims.

What is claimed is:

1. A screen recording method of an extended reality device, comprising:
acquiring a target pose corresponding to an extended reality (XR) device at time t, wherein the target pose is a pose at the time t or a first predicted pose at time t+m;
performing pose stabilization processing on the target pose to obtain a stabilized pose, wherein the pose stabilization processing comprises performing reverse compensation on a roll angle of the target pose;
performing screen recording on a rendering result of a virtual scene based on the stabilized pose to obtain a screen recording image at a time corresponding to the target pose, and storing the screen recording image.

2. The method according to claim 1, wherein the performing reverse compensation on a roll angle of the target pose comprises:
performing reverse compensation on the roll angle of the target pose, so that a value of the roll angle of the target pose after reverse compensation is a preset value.

3. The method according to claim 1, wherein the performing reverse compensation on a roll angle of the target pose comprises:
when the roll angle of the target pose is greater than or equal to a preset angle threshold, performing reverse compensation on the roll angle of the target pose, so that a value of the roll angle of the target pose after reverse compensation is a preset value or the angle threshold;
or, when the roll angle of the target pose is greater than or equal to a preset angle threshold, performing reverse compensation on the roll angle of the target pose according to a preset compensation angle.

4. The method according to claim 1, wherein the performing reverse compensation on a roll angle of the target pose comprises:
performing reverse compensation on the roll angle of the target pose according to a preset compensation ratio.

5. The method according to claim 1, wherein the pose stabilization processing further comprises: performing filtering processing on the target pose:
wherein the filtering processing adopts any one of the following filtering modes: Bayesian filtering, wavelet filtering, Kalman filtering, Wiener filtering, Butterworth filtering, Chebyshev filtering, B-spline fitting or multiple fitting.

6. The method according to claim 5, wherein the performing filtering processing on the target pose comprises:
filtering at least one of a pitch angle or yaw angle of the target pose.

7. The method according to claim 1, further comprising:
rendering the virtual scene based on the first predicted pose at the time t+m to obtain a first rendering result;
wherein the performing screen recording on a rendering result of a virtual scene based on the stabilized pose to obtain a screen recording image at a time corresponding to the target pose comprises:
performing screen recording based on the stabilized pose and the first rendering result to obtain a screen recording image at the time corresponding to the target pose.

8. The method according to claim 7, wherein the performing screen recording based on the stabilized pose and the first rendering result to obtain a screen recording image at the time corresponding to the target pose comprises:
warping the first rendering result based on the stabilized pose to obtain a first warp result;
capturing the first warp result to obtain a screen recording image at the time corresponding to the target pose.

9. The method according to claim 7, further comprising:
acquiring a pose of the XR device at time t+n, and predicting a second predicted pose of the XR device at the time t+m based on the pose at the time t+n, where the value of n is less than m;
warping the first rendering result based on the second predicted pose to obtain a second warp result, capturing the second warp result at the time t+m and then displaying it on screen.

10. The method according to claim 1, wherein the performing screen recording on a rendering result of a virtual scene based on the stabilized pose to obtain a screen recording image at a time corresponding to the target pose comprises:
rendering the virtual scene based on the stabilized pose to obtain a second rendering result;
capturing the second rendering result to obtain a screen recording image at the time corresponding to the target pose.

11. The method according to claim 10, further comprising:
rendering the virtual scene based on the first predicted pose at the time t+m to obtain a first rendering result;
acquiring a pose of the XR device at time t+n, and predicting a second predicted pose of the XR device at the time t+m based on the pose at the time t+n, where the value of n is less than m;
warping the first rendering result based on the second predicted pose to obtain a second warp result, capturing the second warp result at the time t+m and then displaying it on screen.

12. The method according to claim 10, wherein the rendering the virtual scene based on the stabilized pose to obtain a second rendering result comprises:
locally rendering the virtual scene based on the stabilized pose to obtain the second rendering result.

13. The method according to claim 7, wherein the rendering the virtual scene based on the first predicted pose at the time t+m to obtain a first rendering result comprises:
globally rendering the virtual scene based on the first predicted pose to obtain the first rendering result.

14. An extended reality device, comprising:
a processor and a memory, wherein the memory is used for storing a computer program, and the processor is used for calling and operating the computer program stored in the memory to execute a screen recording method of an extended reality device, comprising:
acquiring a target pose corresponding to an extended reality (XR) device at time t, wherein the target pose is a pose at the time t or a first predicted pose at time t+m;
performing pose stabilization processing on the target pose to obtain a stabilized pose, wherein the pose stabilization processing comprises performing reverse compensation on a roll angle of the target pose;
performing screen recording on a rendering result of a virtual scene based on the stabilized pose to obtain a screen recording image at a time corresponding to the target pose, and storing the screen recording image.

15. The extended reality device according to claim 14, wherein the performing reverse compensation on a roll angle of the target pose comprises:
performing reverse compensation on the roll angle of the target pose, so that a value of the roll angle of the target pose after reverse compensation is a preset value.

16. The extended reality device according to claim 14, wherein the performing reverse compensation on a roll angle of the target pose comprises:
when the roll angle of the target pose is greater than or equal to a preset angle threshold, performing reverse compensation on the roll angle of the target pose, so that a value of the roll angle of the target pose after reverse compensation is a preset value or the angle threshold;
or, when the roll angle of the target pose is greater than or equal to a preset angle threshold, performing reverse compensation on the roll angle of the target pose according to a preset compensation angle.

17. The extended reality device according to claim 14, wherein the performing reverse compensation on a roll angle of the target pose comprises:
performing reverse compensation on the roll angle of the target pose according to a preset compensation ratio.

18. A non-transitory computer-readable storage medium, configured for storing a computer program that causes a computer to execute a screen recording method of an extended reality device, comprising:
acquiring a target pose corresponding to an extended reality (XR) device at time t, wherein the target pose is a pose at the time t or a first predicted pose at time t+m;
performing pose stabilization processing on the target pose to obtain a stabilized pose, wherein the pose stabilization processing comprises performing reverse compensation on a roll angle of the target pose;
performing screen recording on a rendering result of a virtual scene based on the stabilized pose to obtain a screen recording image at a time corresponding to the target pose, and storing the screen recording image.

19. The non-transitory computer-readable storage medium according to claim 18, wherein the performing reverse compensation on a roll angle of the target pose comprises:
performing reverse compensation on the roll angle of the target pose, so that a value of the roll angle of the target pose after reverse compensation is a preset value.

20. The non-transitory computer-readable storage medium according to claim 18, wherein the performing reverse compensation on a roll angle of the target pose comprises:
when the roll angle of the target pose is greater than or equal to a preset angle threshold, performing reverse compensation on the roll angle of the target pose, so that a value of the roll angle of the target pose after reverse compensation is a preset value or the angle threshold;
or, when the roll angle of the target pose is greater than or equal to a preset angle threshold, performing reverse compensation on the roll angle of the target pose according to a preset compensation angle.
